(19) United States
(12) Patent Application Publication
(10) Pub. No.: US 2014/0211355 A1
(43) Pub. Date: Jul. 31, 2014

(54) SURGE PROTECTOR

(71) Applicant: Tsan-Chi CHEN, New Taipei City (TW)

(72) Inventor: Tsan-Chi CHEN, New Taipei City (TW)

(21) Appl. No.: 14/162,078

(22) Filed: Jan. 23, 2014

(30) Foreign Application Priority Data
Jan. 30, 2013 (TW) 102103470

(51) Int. Cl. H02H 5/04

(52) U.S. Cl. CPC H02H 5/047
USPC 361/105

(57) ABSTRACT

The present invention is to provide a surge protector which includes an insulating base having a receiving space and a spare space therein; a dielectric material provided in the receiving space; a first conductive plate enclosed in the insulating base, contacted with one side of the dielectric material and having a first pin formed out of the insulating base; a second conductive plate enclosed in the insulating base and having a first side contacted with the other side of the dielectric material, and a temperature-actuated metal plate enclosed in the insulating base and having a second pin formed out of the insulating base. The temperature-actuated metal plate has a temperature-actuated portion which lies against a second side of the second conductive plate when in a low-temperature state, however, when in a high-temperature state, the temperature-actuated portion curves toward the spare space and thus separates from the second conductive plate.

### FIELD OF THE INVENTION

The present invention relates to a surge protector, more particularly to a surge protector applicable to a power supply circuit of an electronic device and having a dielectric material in contact with two conductive plates by two corresponding side surfaces thereof respectively, which not only allows a shock current to pass through the dielectric material evenly for effectively reducing the damage that the shock current may cause to the dielectric material, but also can dissipates heat from the dielectric material both rapidly and evenly through the two conductive plates for significantly slowing the rise of temperature. In addition, the surge protector further includes a temperature-actuated metal plate having a temperature-actuated portion which lies against one of the two conductive plates when in a low-temperature state and will curve toward the spare space when in a high-temperature state and separate from the conductive plate, such that the tripping of the temperature-actuated portion effectively controls the temperature of the surge protector by opening the circuit through the surge protector under high heat. Consequently, the dielectric material is kept from rapid aging which may otherwise result from heat accumulation.

### BACKGROUND OF THE INVENTION

With the advanced development of microelectronic technology, electronic devices have been more and more sophisticated in design. To ensure normal operation of such electronic devices, the industry has endeavored to prevent damages attributable to surges flowing through the circuits of these devices.

Surges, also known as voltage (or current) spikes, can be generally divided by source into those generated outside a circuit and those generated within a circuit. The former is mostly the result of lightning taking place around or directly striking a circuit and is hence called lightning surges. The latter often accompanies the switching of an electronic switch in a circuit and is therefore also referred to as switching surges.

If an electronic device is provided with a control element such as a relay, a switch, or a solenoid, the control element is very likely to be turned on and off a great number of times during operation of the device, thereby generating a lot of surges, which may have undesirable effects on the circuits of the electronic device and give rise to false actions. One conventional solution is to install a surge protector in the power supply circuit of the electronic device, wherein the surge protector forms a discharge path upon occurrence of a surge and can guide the surge to a grounding end of the circuit, thus protecting the electronic device from damage which may otherwise result from the surge.

Metal oxide varistors (MOVs) are dielectric elements traditionally used in surge protectors. The most common MOVs are polycrystalline semiconductor ceramic elements made by sintering zinc oxide grains with a small amount of other metal oxides or polymers. Within such an MOV, the boundaries between the zinc oxide grains and the other metal oxides adjacent to the zinc oxide grains form boundary layers where diode effects occur. As an MOV contains a vast amount of disorderly zinc oxide grains, the entire MOV is equivalent to an aggregate of a large number of diodes connected back to back. When the MOV is subjected to a low voltage, only a small reverse leak current flows through the MOV, but when a high voltage is applied to the MOV, the punch-through effect takes place, causing the large current of the high voltage to pass through the MOV. The reason why MOVs are extensively used in making surge protectors lies in their non-linear current-voltage characteristic curves, in which electrical resistance is high under a low voltage and low under a high voltage.

While surge discharge can be achieved using surge protectors made of MOVs, thanks to the non-linear current-voltage characteristic attributable to the boundary layers of the zinc oxide grains, a long-term observation by the inventor of the present invention, however, reveals the various design drawbacks of the conventional surge protectors. First of all, as the wires and MOVs of a conventional surge protector are connected via “line contact”, the limited areas at the fixed connection regions between the MOVs and the wires result in an extremely high voltage and current per unit area, which tends to cause breakage of the physical connections. Moreover, due to the extremely high voltage and current that the MOVs have to withstand per unit area, a strong transient overvoltage may pass through the MOVs and form through holes in the resistors such that an even larger current runs through the resistors in an instant, causing high heat or fire, the phenomenon being known as “transient overvoltage damage”. Apart from that, research results show that an MOV which has undergone the impact of large currents many times tends to age prematurely even if no transient breakup or fire occurs, and premature aging will eventually lead to linearization of the low resistance range and formation of weak points. Once a large leak current flows to the weak points in a concentrated manner, the weak points may melt and become short-circuit holes. Should a large current gush into the short-circuit holes, high heat and consequently fire will occur.

According to the above description, the conventional surge protectors are so designed that, after multiple instances of passing relatively high-voltage currents (e.g., switching surges) or extremely high-voltage currents (e.g., lightning surges), their wires or MOV plates may be irrevocably damaged. Not only may the MOVs themselves age rapidly during use, but also the fixed connection regions between the MOVs and the wires may break such that the surge discharge function is totally lost.

As far as ordinary consumers are concerned, the more sophisticated and expensive an electronic device is, the more emphasis tends to be placed on its surge protection function, with the purpose of preventing losses associated with any damage of the electronic device. Most consumers believe that the surge protector in an electronic device can provide complete protection for the device; however, the aforesaid drawbacks of the conventional surge protectors make long-term overvoltage protection impossible. When the MOVs become aged or when the fixed connections between the MOVs and the wires are broken, the surge protector fails to discharge surges. If another surge strikes now, the sophisticated and expensive electronic device to be protected by the surge protector will be severely damaged, causing a huge property loss. Furthermore, as the design of the conventional surge protectors cannot protect the MOVs from high heat, the MOVs may burn under high heat, increasing the risk of fire.

Hence, the issue to be addressed by the present invention is to design a surge protector capable of discharging surges repeatedly so that the surge protector will not fail as would the conventional ones with broken or burned MOVs. Thus, an electronic device equipped with the surge protector will be effectively kept from damage resulting from surges.

### BRIEF SUMMARY OF THE INVENTION

In view of the aforesaid shortcomings of the conventional surge protectors, the inventor of the present invention incorporated years of practical experience in the related industry into designing and repeated experiments and finally succeeded in developing a surge protector as disclosed herein. The present invention is intended to substantially increase the durability of a surge protector and thereby effectively enhance the safety of electronic devices during use.

It is an object of the present invention to provide a surge protector which includes an insulating base, a dielectric material, a first conductive plate, a second conductive plate, and a temperature-actuated metal plate. The insulating base defines therein a receiving space and a spare space. The dielectric material is a polycrystalline semiconductor ceramic element containing zinc oxide and is provided in the receiving space. The first conductive plate is enclosed in the insulating base and is attached to one side of the dielectric material by surface contact. The portion of the first conductive plate that extends out of the insulating base forms a first pin. The second conductive plate is also enclosed in the insulating base and has a first side attached to the other side of the dielectric material by surface contact. The temperature-actuated metal plate is enclosed in the insulating base, too, and the portion of the temperature-actuated metal plate that extends out of the insulating base forms a second pin. The temperature-actuated metal plate has a first side corresponding in position to the other side (hereinafter the second side) of the second conductive plate, and a second side of the temperature-actuated metal plate corresponds in position to the spare space in the insulating base. The temperature-actuated metal plate has a temperature-actuated portion which lies against the second side of the second conductive plate when in a low-temperature state. When in a high-temperature state, however, the temperature-actuated portion curves toward the spare space and thus separates from the second conductive plate. As the first conductive plate and the second conductive plate are respectively attached to the two corresponding sides of the dielectric material by surface contact, the surge protector not only allows a shock current flowing therethrough to pass through the dielectric material evenly for effectively reducing the damage that the shock current may cause to the dielectric material, but also can dissipate heat from the dielectric material both rapidly and evenly through the first conductive plate and the second conductive plate for significantly slowing the rise of temperature. Besides, the tripping of the temperature-actuated portion effectively controls the temperature of the surge protector by opening the circuit through the surge protector under high heat. Consequently, the dielectric material is kept from rapid aging which may otherwise result from heat accumulation.

### BRIEF DESCRIPTION OF THE SEVERAL VIEWS OF THE DRAWINGS

The structure as well as further objects and advantages of the present invention will be best understood by referring to the following detailed description of some illustrative embodiments in conjunction with the accompanying drawings, in which:

FIG. 1 is an exploded perspective view of the first preferred embodiment of the present invention;

FIG. 2 is a sectional view of the first preferred embodiment of the present invention in a normal state;

FIG. 3 is a sectional view of the first preferred embodiment of the present invention in a high-temperature state;

FIG. 4 is an exploded perspective view of the second preferred embodiment of the present invention; and

FIG. 5 is a sectional view of the second preferred embodiment of the present invention in a high-temperature state.

### DETAILED DESCRIPTION OF THE INVENTION

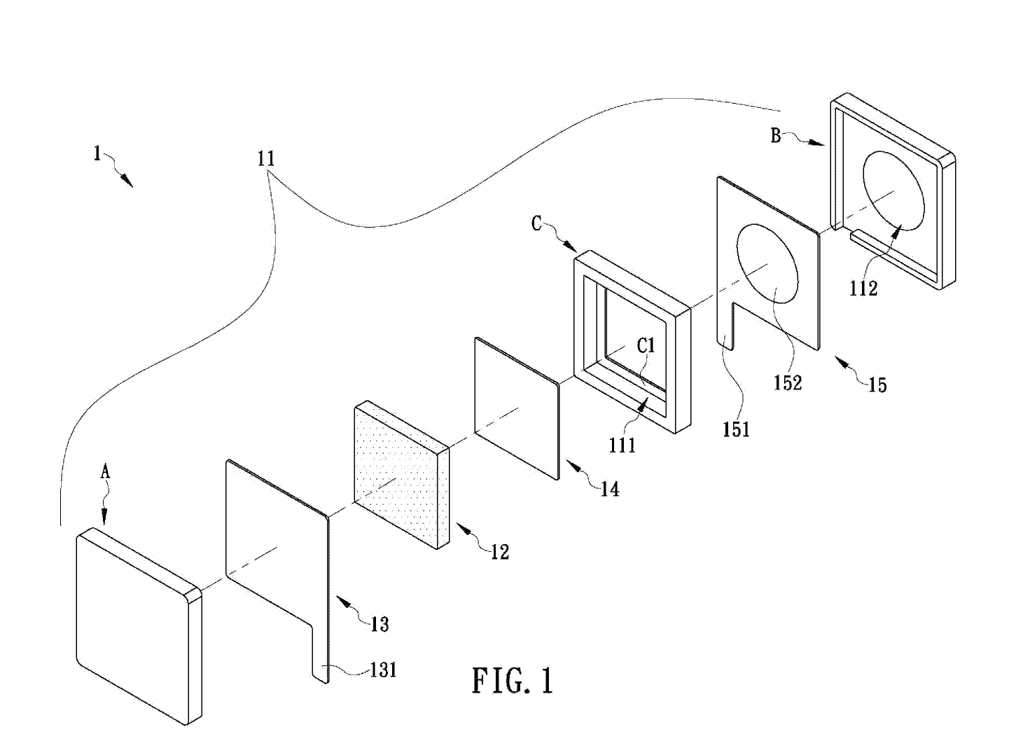

The present invention discloses a surge protector applicable to the power supply circuit of an electronic device. Referring to FIG. 1 for an exploded perspective view of the first preferred embodiment of the present invention, the surge protector 1 includes an insulating base 11, a dielectric material 12, a first conductive plate 13, a second conductive plate 14, and a temperature-actuated metal plate 15 (e.g., a shape-memory alloy plate). The insulating base 11 defines a receiving space 111 and a spare space 112 therein. In the first preferred embodiment, the insulating base 11 is composed of a first housing A, a second housing B, and an inner frame C. The inner frame C, which is enclosed between the first housing A and the second housing B, is a hollow frame defining the receiving space 111. The spare space 112 is concavely provided in the side of the second housing B that corresponds in position to the inner frame C. The dielectric material 12 is a polycrystalline semiconductor ceramic element containing zinc oxide and is provided in the receiving space 111. When in a low-voltage state, only a small portion of a weak reverse leak current flows through the dielectric material 12, but when a high voltage is applied, the punch-through effect takes place which allows the large current of the high voltage to pass through the dielectric material 12. Thanks to the non-linear current-voltage characteristic of the dielectric material 12 (i.e., having a high resistance under a low voltage and a low resistance under a high voltage), the surge protector 1 provides a surge discharging effect.

The first conductive plate 13 is enclosed in the insulating base 11. In this preferred embodiment, the first conductive plate 13 is located between the first housing A and the inner frame C and is attached to one side of the dielectric material 12 (hereinafter referred to as the first side of the dielectric material 12) by surface contact. The first conductive plate 13 has a portion which extends out of the insulating base 11 to form a first pin 131, allowing the surge protector 1 to electrically connect with a circuit. The second conductive plate 14 is also enclosed in the insulating base 11 and has one side (hereinafter referred to as the first side of the second conductive plate 14) attached to the other side of the dielectric material 12 (hereinafter referred to as the second side of the dielectric material 12) by surface contact. In the first preferred embodiment, both the second conductive plate 14 and the dielectric material 12 are provided in the receiving space 111, and the inner frame C has an inner periphery which corresponds in position to the receiving space 111 and whose one side is adjacent to the second housing B and protrudingly provided with a flange C1. Once the second conductive plate 14 and the dielectric material 12 are sequentially disposed in the receiving space 111, the other side of the second conductive plate 14 (hereinafter referred to as the second side of the second conductive plate 14) is pressed against the flange C1 and is restricted in the receiving space 111 by the flange C1. Meanwhile, the dielectric material 12 is pressed against the first side of the second conductive plate 14 and is restricted in the receiving space 111 by the second conductive plate 14. The foregoing is merely one preferred embodiment of the present invention. In particular, although the flange C1 in the first preferred embodiment is provided continuously along and around the inner periphery of the inner frame C and corresponds in position to the receiving space 111, the present invention is not limited to such a configuration. For example, the flange C1 may be designed as a plurality of spaced-apart projections instead, and these projections as a whole serve as the flange C1. In addition, the arrangement of the second conductive plate 14 may be changed such that the second conductive plate 14 is directly embedded in the inner frame C by insert molding. All equivalent alterations or modifications which are based on the disclosure of the present invention and readily conceivable by a person skilled in the art should fall within the scope of the present invention.

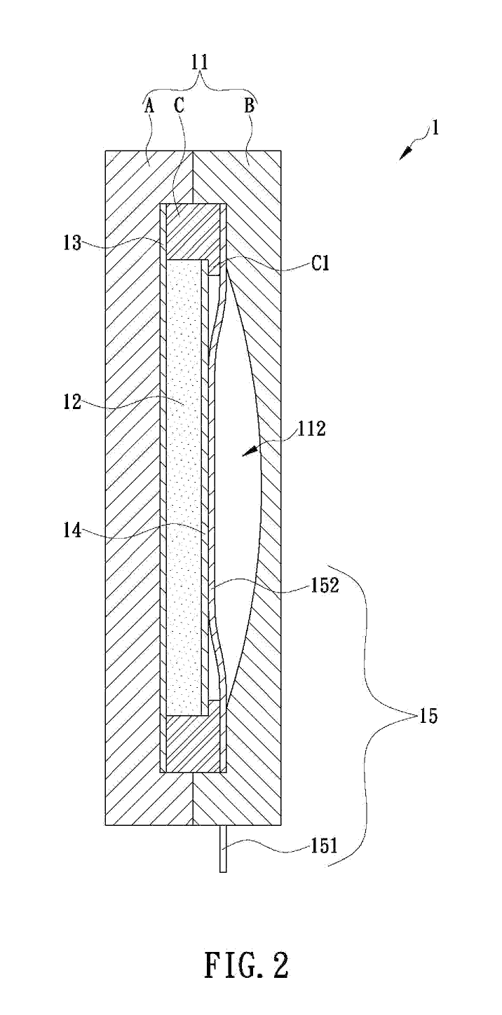

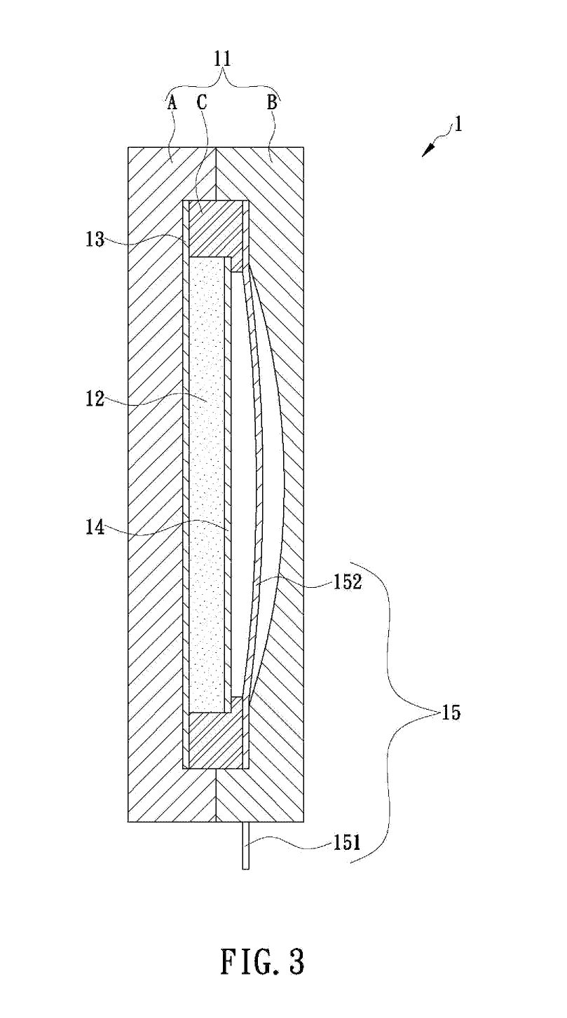

Referring to FIG. 2 and FIG. 3, the temperature-actuated metal plate 15 is enclosed in the insulating base 11. The portion of the temperature-actuated metal plate 15 that extends out of the insulating base 11 forms a second pin 151 so that the surge protector 1 can be electrically connected to a circuit through the temperature-actuated metal plate 15. One side of the temperature-actuated metal plate 15 corresponds in position to the second side of the second conductive plate 14 while the other side of the temperature-actuated metal plate 15 corresponds in position to the spare space 112. When the temperature of the temperature-actuated metal plate 15 reaches a threshold temperature, a temperature-actuated portion 152 of the temperature-actuated metal plate 15 deforms. If there is a current flowing through the surge protector 1, the temperature of the temperature-actuated metal plate 15 will rise. Once the current through the surge protector 1 raises the temperature of the temperature-actuated metal plate 15 beyond the threshold temperature, deformation of the temperature-actuated portion 152 takes place. In the first preferred embodiment, the temperature-actuated portion 152 lies against the second side of the second conductive plate 14 when at a temperature lower than the threshold temperature. When at a temperature higher than the threshold temperature, the temperature-actuated portion 152 curves toward the spare space 112 and separates from the second conductive plate 14. Thus, as soon as the temperature of the surge protector 1 becomes too high, the temperature-actuated portion 152 automatically cuts off the current path through the surge protector 1 to protect the dielectric material 12 from irrevocable damage or premature aging which may otherwise result from an excessively high temperature.

In the first preferred embodiment, the two corresponding sides of the dielectric material 12 are respectively attached to the first conducive plate 13 and the second conductive plate 14 by surface contact. Hence, heat can be rapidly and evenly guided away from the dielectric material 12 through the first conductive plate 13 and the second conductive plate 14 to achieve optimal heat dissipation. However, the present invention is not limited to the foregoing design. For instance, the surge protector 1 may be so designed as to dispense with the second conductive plate 14. In that case, the spacing between the temperature-actuated metal plate 15 and the dielectric material 12 should be adjusted as appropriate, allowing the temperature-actuated portion 152 to lie against the second side of the dielectric material 12 in a low-temperature (i.e., lower than the threshold temperature) state and to separate from the dielectric material 12 in a high-temperature (i.e., higher than the threshold temperature) state. While the omission of the second conductive plate 14 compromises heat dissipation efficiency of the surge protector 1, structural complexity is effectively reduced, and material and assembly costs can be lowered. As the temperature-actuated metal plate 15 can still automatically cut off the current path through the surge protector 1 when the temperature of the surge protector 1 becomes too high, the intended effect of preventing heat accumulation is retained.

It can be known from the above that the surface-contact attachment of the first conductive plate 13 and the second conductive plate 14 to the two corresponding sides of the dielectric material 12 not only allows a current through the surge protector 1 to be evenly distributed over the dielectric material 12, but also keeps the dielectric material 12 from passing a shock current through a single point. Moreover, the first conductive plate 13 and the second conductive plate 14 can rapidly dissipate heat from the dielectric material 12, and the tripping of the temperature-actuated portion 152 can effectively control the temperature of the surge protector 1 by opening the circuit of the surge protector 1 in a high-temperature state, thus avoiding heat accumulation and hence premature aging of the dielectric material 12. In other word, the surge protector 1 of the present invention solves the aforementioned problems of the conventional surge protectors, which mainly include failure to discharge surges because the MOVs are broken or burned. As stated previously, such failure may cause damage to the electronic devices being protected, and the burning of the MOVs may cause fire. The surge protector 1 of the present invention, on the other hand, features a long service life and is greatly enhanced in safety.

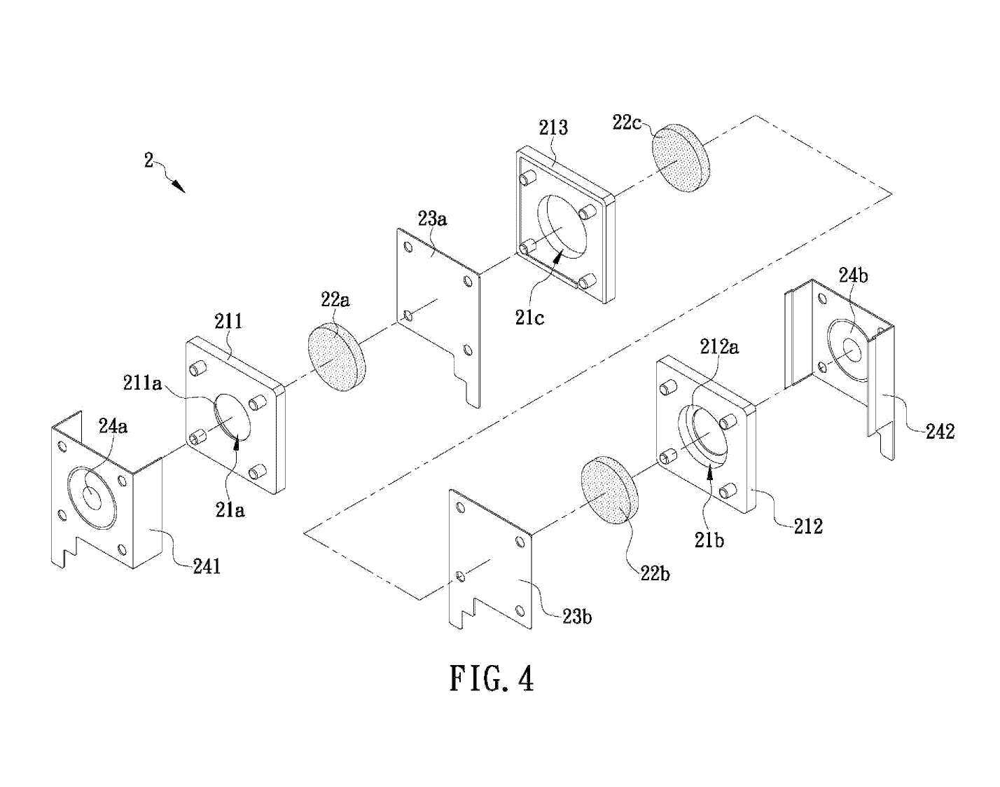

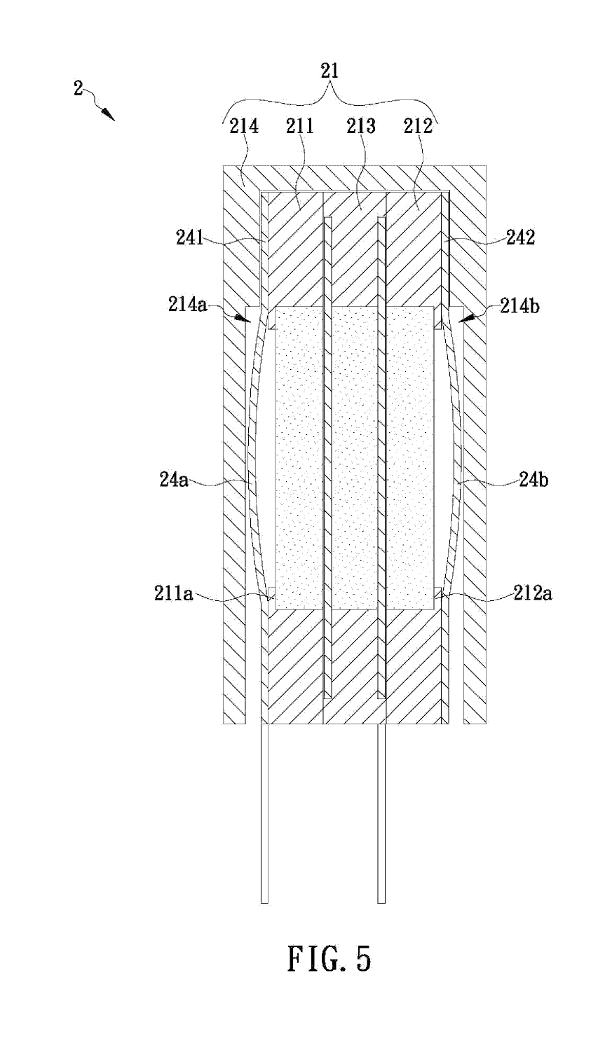

Please refer to FIG. 4 for an exploded perspective view of the second preferred embodiment of the present invention and to FIG. 5 for a sectional view of the second preferred embodiment in a high-temperature state. In the second preferred embodiment, the surge protector 2 includes an insulating base 21, a first dielectric material 22a, a second dielectric material 22b, a third dielectric material 22c, a first conductive plate 23a, a second conductive plate 23b, a first temperature-actuated metal plate 241, and a second temperature-actuated metal plate 242. In the second preferred embodiment, the insulating base 21 is composed of a first base 211, a second base 212, a third base 213, and a cover 214. The first base 211 defines a first receiving space 21a therein, and the inner periphery of the first base 211, which corresponds in position to the first receiving space 21a, is provided with a first flange 211a on one side. The second base 212 defines a second receiving space 21b therein, and the inner periphery of the second base 212, which corresponds in position to the second receiving space 21b, is provided with a second flange 212a on one side. The third base 213 defines a third receiving space 21c therein. The receiving spaces 21a, 21b, and 21c are configured for receiving the dielectric materials 22a, 22b, and 22c respectively, with a first side of the first dielectric material 22a pressed against the first flange 211a and a first side of the second dielectric material 22b pressed against the second flange 212a. The first conductive plate 23a is located between the first base 211 and the third base 213 and has two sides respectively pressed against the other side (hereinafter the second side) of the first dielectric material 22a and one side (hereinafter the first side) of the third dielectric material 22c. The second conductive plate 23b is located between the second base 212 and the third base 213 and has two sides respectively pressed against the other side (hereinafter the second side) of the second dielectric material 22b and the other side (hereinafter the second side) of the third dielectric material 22c.

With continued reference to FIG. 4 and FIG. 5, the first temperature-actuated metal plate 241 encloses the side of the first base 211 that faces away from the third base 213, and the second temperature-actuated metal plate 242 encloses the side of the second base 212 that faces away from the third base 213. After the first temperature-actuated metal plate 241, the first base 211, the first conductive plate 23a, the third base 213, the second conductive plate 23b, the second base 212, and the second temperature-actuated metal plate 242 are sequentially put together, the first temperature-actuated metal plate 241 and the second temperature-actuated metal plate 242 are electrically connected to each other. In addition, once the aforesaid elements are assembled as a single unit, the cover 214 is mounted around and encloses the single unit. The two corresponding inner sides of the cover 214 define a first spare space 214a and a second spare space 214b respectively. The first spare space 214a and the second spare space 214b correspond in position to the first temperature-actuated metal plate 241 and the second temperature-actuated metal plate 242 respectively. The first temperature-actuated metal plate 241 and the second temperature-actuated metal plate 242 are respectively provided with a first temperature-actuated portion 24a and a second temperature-actuated portion 24b. The first temperature-actuated portion 24a and the second temperature-actuated portion 24b lie respectively against the first side of the first dielectric material 22a and the first side of the second dielectric material 22b when in a low-temperature (i.e., lower than a threshold temperature) state and curve toward the first spare space 214a and the second spare space 214b respectively when in a high-temperature (i.e., higher than the threshold temperature) state (as shown in FIG. 5).

When the surge protector 2 of the second preferred embodiment is applied to the power supply circuit of an electronic device, the pins of the first temperature-actuated metal plate 241 and second temperature-actuated metal plate 242 are respectively connected to a grounding circuit, and the first conductive plate 23a and the second conductive plate 23b are respectively connected to the live line and the zero line (also known as the neutral line) of the power supply circuit. Thus, when a surge occurs, the shock current of the surge will flow through the first temperature-actuated metal plate 241 or the second temperature-actuated metal plate 242 of the surge protector 2 and be guided to the grounding circuit to protect the electronic device from damage by the surge. In the second preferred embodiment, when one of the first dielectric material 22a and the second dielectric material 22b has a higher temperature than the other such that the temperature of the first temperature-actuated metal plate 241 or the second temperature-actuated metal plate 242 exceeds the threshold temperature, the corresponding first temperature-actuated portion 24a or second temperature-actuated portion 24b will trip and therefore no more press against the first dielectric material 22a or the second dielectric material 22b. Meanwhile, however, the surge in the circuit can still be discharged to the grounding circuit via the first temperature-actuated metal plate 241 or the second temperature-actuated metal plate 242 that has not tripped. In other words, the surge protector 2 of the second preferred embodiment is so designed that, while the first temperature-actuated metal plate 241 and the second temperature-actuated metal plate 242 protect the first dielectric material 22a and the second dielectric material 22b from damage, the electronic device intended to be protected is also under protection because the surge discharge function will not be temporarily lost during the time when the temperature of the first temperature-actuated metal plate 241 or the second temperature-actuated metal plate 242 has yet to fall below the threshold temperature.

Referring to FIGS. 1, 4, and 5, in the second preferred embodiment, the first temperature-actuated metal plate 241, the first base 211, the first conductive plate 23a, the third base 213, and the cover 214 are arranged in a way that is similar to the arrangement of the first preferred embodiment of the present invention. More specifically, the surge protector 2 is equivalent to two surge protectors 1 stacked together, wherein the third base 213 is equivalent to the first housing A in the first preferred embodiment. This first housing A is shared by the two surge protectors 1 and is additionally formed with a receiving space (i.e., the third receiving space 21c in the second preferred embodiment) for receiving a dielectric material (i.e., the third dielectric material 22c in the second preferred embodiment). One advantageous feature of the second preferred embodiment is that, under the premise of effectively extending the service life of the surge protector 2, the stacked arrangement further increases surge discharge efficiency of the surge protector 2 and thereby greatly enhances the practical value and safety of the surge protector 2 in use. Another advantageous feature of the second preferred embodiment is to connect the pins of the first temperature-actuated metal plate 241 and second temperature-actuated metal plate 242 respectively to a grounding circuit and to connect the first conductive plate 23a and the second conductive plate 23b respectively to the live line and the zero line of a power supply circuit. Thus, when it is desired to apply the surge protector 2 directly to the power supply circuit of an electronic device, only a single surge protector 2 has to be installed to provide complete protection. In the first preferred embodiment, however, three surge protectors 1 must be installed respectively “between the grounding circuit and the live line”, “between the grounding circuit and the zero line”, and “between the live line and the zero line”. Therefore, the second preferred embodiment also features increased ease of installation.

While the invention herein disclosed has been described by means of specific embodiments, numerous modifications and variations could be made thereto by those skilled in the art without departing from the scope of the invention set forth in the claims

What is claimed is:

1. A surge protector, applicable to a power supply circuit of an electronic device, the surge protector comprising:
an insulating base defining therein a receiving space and a spare space;
a dielectric material being a polycrystalline semiconductor ceramic element containing zinc oxide, the dielectric material being provided in the receiving space;
a first conductive plate enclosed in the insulating base and attached to a first side of the dielectric material by surface contact, the first conductive plate having a portion which extends out of the insulating base and forms a first pin;
a second conductive plate enclosed in the insulating base and having a first side attached to a second side of the dielectric material by surface contact; and
a temperature-actuated metal plate enclosed in the insulating base, the temperature-actuated metal plate having a portion which extends out of the insulating base and forms a second pin, the temperature-actuated metal plate having a first side corresponding in position to a second side of the second conductive plate and a second side corresponding in position to the spare space in the insulating base, wherein a temperature-actuated portion of the temperature-actuated metal plate lies against the second side of the second conductive plate when at a temperature lower than a threshold temperature, and the temperature-actuated portion curves toward the spare space and separates from the second conductive plate when at a temperature higher than the threshold temperature.

2. The surge protector of claim 1, wherein the insulating base has an inner periphery corresponding in position to the receiving space, the inner periphery has a side adjacent to the spare space and protrudingly provided with a flange, and the second side of the second conductive plate is pressed against the flange.

3. The surge protector of claim 2, wherein the insulating base is composed of a first housing, a second housing, and an inner frame, and the inner frame is enclosed between the first housing and the second housing.

4. The surge protector of claim 3, wherein the spare space is concavely provided in a side of the second housing that corresponds in position to the inner frame.

5. The surge protector of claim 3, wherein the receiving space is formed in the inner frame.

6. The surge protector of claim 4, wherein the surge protector can be stacked on, and share the first housing with, another said surge protector.

7. The surge protector of claim 5, wherein the surge protector can be stacked on, and share the first housing with, another said surge protector.

8. The surge protector of claim 6, wherein the first housing is further formed with another receiving space, the another receiving space is provided therein with another dielectric material, and the another dielectric material has two sides lying respectively against the first conductive plate of the surge protector and the first conductive plate of the another surge protector.

9. The surge protector of claim 7, wherein the first housing is further formed with another receiving space, the another receiving space is provided therein with another dielectric material, and the another dielectric material has two sides lying respectively against the first conductive plate of the surge protector and the first conductive plate of the another surge protector.

10. A surge protector, applicable to a power supply circuit of an electronic device, the surge protector comprising:
an insulating base defining therein a receiving space and a spare space;
a dielectric material being a polycrystalline semiconductor ceramic element containing zinc oxide, the dielectric material being provided in the receiving space;
a conductive plate enclosed in the insulating base and attached to a first side of the dielectric material by surface contact, the conductive plate having a portion which extends out of the insulating base and forms a first pin; and
a temperature-actuated metal plate enclosed in the insulating base, the temperature-actuated metal plate having a portion which extends out of the insulating base and forms a second pin, the temperature-actuated metal plate having a first side corresponding in position to a second side of the dielectric material and a second side corresponding in position to the spare space in the insulating base, wherein a temperature-actuated portion of the temperature-actuated metal plate lies against the second side of the dielectric material when at a temperature lower than a threshold temperature, and the temperature-actuated portion curves toward the spare space and separates from the dielectric material when at a temperature higher than the threshold temperature.

11. The surge protector of claim 10, wherein the insulating base has an inner periphery corresponding in position to the receiving space, the inner periphery has a side adjacent to the spare space and protrudingly provided with a flange, and the second side of the dielectric material is pressed against the flange.

12. The surge protector of claim 11, wherein the insulating base is composed of a first housing, a second housing, and an inner frame, and the inner frame is enclosed between the first housing and the second housing.

13. The surge protector of claim 12, wherein the spare space is concavely provided in a side of the second housing that corresponds in position to the inner frame.

14. The surge protector of claim 12, wherein the receiving space is formed in the inner frame.

15. The surge protector of claim 13, wherein the surge protector can be stacked on, and share the first housing with, another said surge protector.

16. The surge protector of claim 14, wherein the surge protector can be stacked on, and share the first housing with, another said surge protector.

17. The surge protector of claim 15, wherein the first housing is further formed with another receiving space, the another receiving space is provided therein with another dielectric material, and the another dielectric material has two sides lying respectively against the conductive plate of the surge protector and the conductive plate of the another surge protector.

18. The surge protector of claim 16, wherein the first housing is further formed with another receiving space, the another receiving space is provided therein with another dielectric material, and the another dielectric material has two sides lying respectively against the conductive plate of the surge protector and the conductive plate of the another surge protector.
